(19) United States
(12) Patent Application Publication
(10) Pub. No.: US 2024/0136662 A1
(43) Pub. Date: Apr. 25, 2024

(54) ELECTRODE BODY, RECHARGEABLE BATTERY, AND METHOD FOR MANUFACTURING ELECTRODE BODY

(71) Applicants: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(72) Inventor: Ryotaro SAKAI, Toyohashi-shi (JP)

(73) Assignees: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(21) Appl. No.: 18/382,473

(22) Filed: Oct. 19, 2023

(30) Foreign Application Priority Data
Oct. 24, 2022 (JP) 2022-170641

(51) Int. Cl. H01M 50/46; H01M 10/04

(52) U.S. Cl. CPC H01M 50/46; H01M 10/0431

(57) ABSTRACT

An electrode body includes a stack of a negative electrode plate, a positive electrode plate, and a separator in which the separator is arranged between the negative electrode plate and the positive electrode plate. The positive electrode plate has a positive electrode density of 3.0 g/cm³ or less. The negative electrode plate has a negative electrode density of 1.3 g/cm³ or less. A ratio of a specific surface area of the positive electrode plate to a specific surface area of the negative electrode plate is 0.7 or greater.

### BACKGROUND

### 1. Field

The following description relates to an electrode body, a rechargeable battery, and a method for manufacturing an electrode body.

### 2. Description of Related Art

A typical non-aqueous rechargeable battery includes an electrode body having a negative electrode plate, a positive electrode plate, and a separator. Such an electrode body is accommodated in a battery case together with a non-aqueous electrolyte in a state in which the negative electrode plate, the positive electrode plate, and the separator are stacked in a thickness-wise direction. Each electrode plate includes a current collector on which an electrode mixture layer is formed. The electrode mixture layer includes at least an active material. When an electrode plate is manufactured, the specific surface area of the electrode plate affects the properties of the non-aqueous rechargeable battery, such as capacity.

Japanese Laid-Open Patent Publication No. 2003-272611 discloses a method for manufacturing a non-aqueous rechargeable battery that uses a positive electrode active material having a specific surface area in a range of 0.6 to 1.5 m²/g so that the positive electrode plate will have a specific surface area in a range of 0.5 to 2 m²/g. This method provides a non-aqueous rechargeable battery having excellent discharge characteristics and output characteristics.

In this type of non-aqueous rechargeable battery, it is desired that a new index for specific surface area be used during the manufacture of the electrode plate to further improve the characteristics of the non-aqueous rechargeable battery. For example, Japanese Laid-Open Patent Publication No. 2004-006275 discloses a non-aqueous electrolyte rechargeable battery that adjusts the specific surface area of an electrode having a high density to stabilize the discharge characteristics when a large current is applied and improve the charge/discharge cycle characteristics. However, due to the high density of the electrode, an electrolyte of Japanese Laid-Open Patent Publication No. 2004-006275 has a low permeation rate.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an electrode body includes a stack of a negative electrode plate, a positive electrode plate, and a separator in which the separator is arranged between the negative electrode plate and the positive electrode plate. The positive electrode plate has a positive electrode density of 3.0 g/cm³ or less. The negative electrode plate has a negative electrode density of 1.3 g/cm³ or less. A ratio of a specific surface area of the positive electrode plate to a specific surface area of the negative electrode plate is 0.7 or greater.

In another general aspect, a rechargeable battery includes an electrode body including a stack of a negative electrode plate, a positive electrode plate, and a separator in which the separator is arranged between the negative electrode plate and the positive electrode plate. The positive electrode plate has a positive electrode density of 3.0 g/cm³ or less. The negative electrode plate has a negative electrode density of 1.3 g/cm³ or less. A ratio of a specific surface area of the positive electrode plate to a specific surface area of the negative electrode plate is 0.7 or greater.

In another general aspect, an electrode body includes a stack of a negative electrode plate, a positive electrode plate, and a separator in which the separator is arranged between the negative electrode plate and the positive electrode plate. A method for manufacturing the electrode body includes setting a positive electrode density of the positive electrode plate to 3.0 g/cm³ or less, setting a negative electrode density of the negative electrode plate to 1.3 g/cm³ or less, and setting a ratio of a specific surface area of the positive electrode plate to a specific surface area of the negative electrode plate to 0.7 or greater.

Other features and aspects will be apparent from the following detailed description, the drawings, and the claims.

### BRIEF DESCRIPTION OF THE DRAWINGS

FIG. 1 is a perspective view of a rechargeable battery in accordance with an embodiment.

FIG. 2 is a diagram showing the structure of an electrode body.

FIG. 3 is a flowchart illustrating a production procedure of the rechargeable battery.

FIG. 4 is a table showing index values in examples and comparative examples.

FIG. 5 is a model diagram showing the material of a positive electrode plate subsequent to pressing.

FIG. 6 is a model diagram showing the material of a positive electrode plate subsequent to pressing.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

An embodiment of an electrode body, a rechargeable battery, and a method for manufacturing an electrode body will now be described.

Rechargeable Battery 1

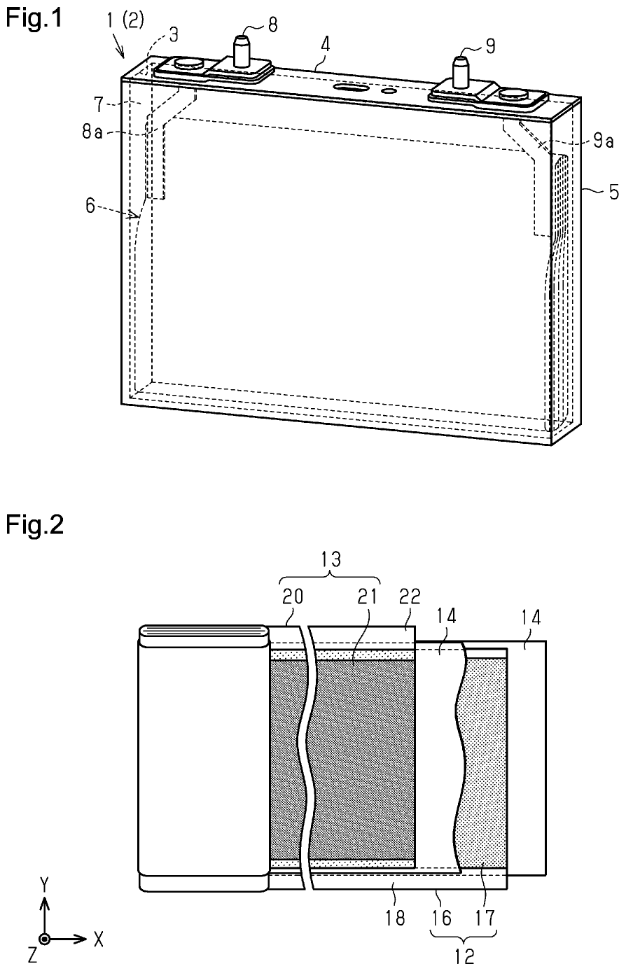

As shown in FIG. 1, a cell 2 of a rechargeable battery 1 includes a box-shaped battery case 5 having an opening 3 and a lid 4 that closes the opening 3. The battery case 5 is formed from, for example, a metal such as an aluminum alloy or the like. The battery case 5 forms a sealed battery container. The battery case 5 accommodates an electrode body 6 in which positive and negative electrodes are stacked. The battery case 5 is filled with a non-aqueous electrolyte 7. The lid 4 of the cell 2 includes a positive electrode external terminal 8 and a negative electrode external terminal 9 that are electrically connected to the electrode body 6. For example, the rechargeable battery 1 is of a lithium-ion type that uses lithium ions that move between the positive and negative electrodes.

Electrode Body 6

As shown in FIG. 2, the electrode body 6 includes a negative electrode plate 12, a positive electrode plate 13, and a separator 14. The negative electrode plate 12, the positive electrode plate 13, and the separator 14 are stacked in a thickness-wise direction (Z-axis direction in FIG. 2) of the electrode body 6. Specifically, the negative electrode plate 12 and the positive electrode plate 13 are alternately arranged, and the separator 14 is disposed between the negative electrode plate 12 and the positive electrode plate 13. For example, the electrode body 6 may be a rolled electrode body as shown in FIG. 2. The rolled electrode body 6 is formed by rolling a long stack of the negative electrode plate 12, the positive electrode plate 13, and the separator 14 in a longitudinal direction (X-axis direction in FIG. 2) about a rolling axis. In an example, the rolled electrode body 6 is flat as viewed in a direction orthogonal to the longitudinal direction (Y-axis direction in FIG. 2).

Negative Electrode Plate 12

The negative electrode plate 12 includes a negative electrode current collector 16 and a negative electrode mixture layer 17. The negative electrode current collector 16 is the substrate of the negative electrode. The negative electrode current collector 16 is formed from, for example, copper (copper foil). For example, the negative electrode mixture layer 17 is formed on two opposite surfaces of the negative electrode current collector 16. The negative electrode mixture layer 17 includes, for example, a negative electrode active material and a negative electrode additive. The negative electrode mixture layer 17 is formed on the negative electrode current collector 16 by kneading the negative electrode active material and the negative electrode additive to form a negative electrode mixture paste, applying the negative electrode mixture paste to the negative electrode current collector 16, and drying the negative electrode mixture paste.

The negative electrode active material is formed from, for example, a material capable of storing and releasing lithium ions. The negative electrode active material is, for example, a powdered carbon material such as graphite or the like. The negative electrode additive includes, for example, a negative electrode solvent, a negative electrode binder, and a negative electrode thickener. The negative electrode solvent is, for example, water or the like. The negative electrode additive may further include, for example, a negative electrode conductive material and the like.

The negative electrode binder is, for example, a polymeric material that disperses in water. The polymeric material is, for example, a rubber material such as vinyl acetate copolymer, styrene-butadiene block copolymer (SBR), acrylic acid-modified SBR resin (SBR-based latex), gum arabic, or the like. The polymeric material may also be, for example, a fluorine-based resin such as polyethylene oxide (PEO), polytetrafluoroethylene (PTFE), tetrafluoroethylene-perfluoro alkyl vinyl ether copolymer (PFA), tetrafluoroethylene-hexafluoropropylene copolymer (FEP), ethylene-tetrafluoroethylene copolymer (ETFE) or the like. A single type of polymer may be used. Alternatively, two or more types of polymer may be used in combination.

The negative electrode thickener is, for example, a polymer-based material that is insoluble in an organic solvent and increased in viscosity when dissolved in water. The polymer-based material is, for example, a cellulose derivative such as carboxymethyl cellulose (CMC), methyl cellulose (MC), or the like.

The negative electrode current collector 16 includes a negative electrode connecting portion 18 that is connected to the negative electrode external terminal 9 via a negative electrode current collecting plate 9a. For example, the negative electrode connecting portion 18 is where the negative electrode mixture layer 17 is not formed on opposite surfaces of the negative electrode current collector 16 and is configured to be exposed from the positive electrode plate 13 and the separator 14.

Positive Electrode Plate 13

The positive electrode plate 13 includes a positive electrode current collector 20 and a positive electrode mixture layer 21. The positive electrode current collector 20 is the substrate of the positive electrode. The positive electrode current collector 20 is formed from, for example, aluminum (aluminum foil, aluminum alloy foil). The positive electrode mixture layer 21 includes, for example, a positive electrode active material and a positive electrode additive. The positive electrode mixture layer 21 is formed on the positive electrode current collector 20 by kneading the positive electrode active material and the positive electrode additive to form a positive electrode mixture paste, applying the positive electrode mixture paste to the positive electrode current collector 20, and drying the positive electrode mixture paste.

The positive electrode active material is formed from, for example, a material capable of storing and releasing lithium ions. The positive electrode active material is, for example, a three-element lithium-containing composite oxide that contains nickel, manganese, and cobalt (NMC), that is, lithium nickel manganese cobalt oxide (LINICOMNO₂). The positive electrode active material may be, for example, any one of lithium cobalt oxide (LiCoO₂), lithium manganese oxide (LiMn₂O₄), and lithium nickel oxide (LiNiO₂). The positive electrode active material may be, for example, a lithium-containing composite oxide that contains nickel, cobalt, and aluminum (NCA).

The positive electrode additive includes, for example, a positive electrode solvent, a positive electrode conductive material, and a positive electrode binder. The positive electrode solvent is, for example, a non-aqueous solvent such as an N-methyl-2-pyrrolidone (NMP) solution, or the like. For example, the positive electrode binder may be the same as the negative electrode binder. The positive electrode additive may further include, for example, a positive electrode thickener or the like.

The positive electrode conductive material is, for example, carbon fibers such as carbon nanotubes (CNT), carbon nanofibers (CNF), or the like. The carbon-based material acts as cushions during kneading. Thus, it is preferred that the amount of the carbon-based material be minimal. In this respect, carbon nanotubes and carbon nanofibers can ensure conductivity even with a small amount. The positive electrode conductive material may be carbon black such as graphite, acetylene black (AB), ketjen black, or the like.

The positive electrode current collector 20 includes a positive electrode connecting portion 22 that is connected to the positive electrode external terminal 8 by a positive electrode current collecting plate 8a. For example, the positive electrode connecting portion 22 is where the positive electrode mixture layer 21 is not formed on opposite surfaces of the positive electrode current collector 20 and is configured to be exposed from the negative electrode plate 12 and the separator 14.

Separator 14

The separator 14 may be, for example, a nonwoven fabric of polypropylene, which is a porous resin. The separator 14 may be, for example, any one of or a combination of a lithium-ion-conductive polymer electrolyte film, an ion-conductive polymer electrolyte film, and a porous polymer film, such as a porous polyethylene film, a porous polyolefin film, and a porous polyvinyl chloride film. When the electrode body 6 is immersed in the non-aqueous electrolyte 7, the non-aqueous electrolyte 7 permeates the separator 14.

Non-Aqueous Electrolyte 7

The non-aqueous electrolyte 7 is a composition containing a supporting electrolyte in a non-aqueous solvent. The non-aqueous solvent is, for example, ethylene carbonate (EC). The non-aqueous solvent may be one or two or more selected from a group consisting of propylene carbonate (PC), diethyl carbonate (DEC), dimethyl carbonate (DMC), ethyl methyl carbonate (EMC), and the like.

The supporting electrolyte is LiPF₆, LiBF₄, LiClO₄, LiAsF₆, LiCF₃SO₃, LiC₄F₉SO₃, LiN(CF₃SO₂)₂, LiC(CF₃SO₂)₃, LiI or the like. Further, the supporting electrolyte may be one or two or more types of lithium compound (lithium salt) selected from the above compounds. In this manner, the non-aqueous electrolyte 7 includes a lithium compound.

Manufacturing Process of Rechargeable Battery 1

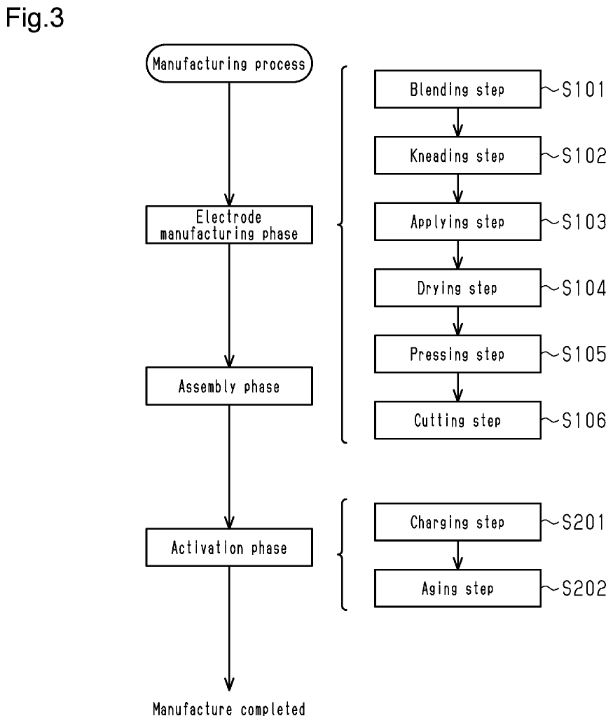

As shown in FIG. 3, a manufacturing process of the rechargeable battery 1 includes an electrode plate manufacturing phase, an assembly phase, and an activation phase. The electrode plate manufacturing phase refers to, for example, steps of manufacturing an electrode plate (negative electrode plate 12, positive electrode plate 13) from a battery material.

The electrode plate manufacturing phase will now be described in detail. The negative electrode plate 12 and the positive electrode plate 13 are manufactured through the substantially same process. Thus, only the manufacturing process of the positive electrode plate 13 is described in the present example.

In step 101, the positive electrode active material and the positive electrode additive, which are raw materials of the positive electrode mixture layer 21, are blended in a blending step. A positive electrode mixture paste is produced in the blending step.

In step 102, the positive electrode mixture paste is kneaded in a kneading step.

In step 103, the positive electrode mixture paste is applied to the positive electrode current collector 20 in an applying step. In the applying step, the positive electrode mixture paste is applied to the positive electrode current collector 20 such that the positive electrode current collector 20 includes the positive electrode connecting portion 22 at two ends on both surfaces.

In step 104, the positive electrode mixture paste applied to the positive electrode current collector 20 is dried in a drying step. In the drying step, the positive electrode mixture paste is solidified on the positive electrode current collector 20 and forms a strip of the positive electrode plate 13.

In step 105, the dried positive electrode plate 13 is pressed in a pressing step. In the pressing step, a pressing machine presses the positive electrode mixture layer 21 formed on both surfaces of the positive electrode current collector 20 to increase the adhesion strength between the positive electrode mixture layer 21 and the positive electrode current collector 20 and adjust the thickness of the positive electrode mixture layer 21.

In step 106, the pressed positive electrode plate 13 is cut in a cutting step. In the cutting step, for example, the positive electrode plate 13 is cut at the center in a widthwise direction to obtain two strips of the positive electrode plate 13 at the same time.

The assembly phase is performed after the electrode plate manufacturing phase to assemble the rechargeable battery 1. In the assembly phase, the negative electrode plate 12, the positive electrode plate 13, and the separator 14 are stacked and rolled. Further, the roll is pressed and flattened. Then, the negative electrode connecting portion 18 and the positive electrode connecting portion 22 are each press-bonded. The electrode body 6 is manufactured through the procedures described above.

Subsequently, the electrode body 6 is accommodated in the battery case 5. After the accommodation, the opening 3 of the battery case 5 is closed by the lid 4. Then, the non-aqueous electrolyte 7 is injected into the battery case 5. After the non-aqueous electrolyte 7 is injected into the battery case 5, the battery case 5 is sealed. The rechargeable battery 1 is assembled through the procedures described above.

The activation phase refers to steps of activating the assembled battery. In step 201 of the activation phase, the rechargeable battery 1 is charged in a charging step. In the charging step, the assembled rechargeable battery 1 undergoes initial charging to, for example, form a solid electrolyte interphase (SEI) coating. For example, the charging step is performed in a bound state in which the rechargeable battery 1 is bound. In this case, the electrode body 6 is also in a bound state. The term “bound” refers to directly or indirectly applying pressure to the electrode body 6 in the thickness-wise direction (for example, Z-axis direction in FIG. 2).

In step 202, the charged rechargeable battery 1 is stored in an aging step. In the aging step, the rechargeable battery 1 undergoes chemical stabilization/activation. One of the purposes of the aging step is to detect micro-short-circuits between electrodes caused by microscopic metal present in the electrodes. In the present embodiment, the aging step may be performed at a high temperature of, for example, approximately 60° C. Alternatively, the aging step may be performed at an outside temperature of approximately 20° C. The aging step is performed under the condition that the rechargeable battery 1 is in a bound state.

After the activation phase, the rechargeable battery 1 is returned from the bound state to a non-bound state. When the rechargeable battery 1 shifts to a non-bound state, the electrode body 6 accommodated in the rechargeable battery 1 shifts to a non-bound state. The rechargeable battery 1 is manufactured as a battery cell through the procedures described above. After a shipment inspection is conducted, the rechargeable battery 1 will be coupled to a stack.

Setting Parameter for Material of Rechargeable Battery 1

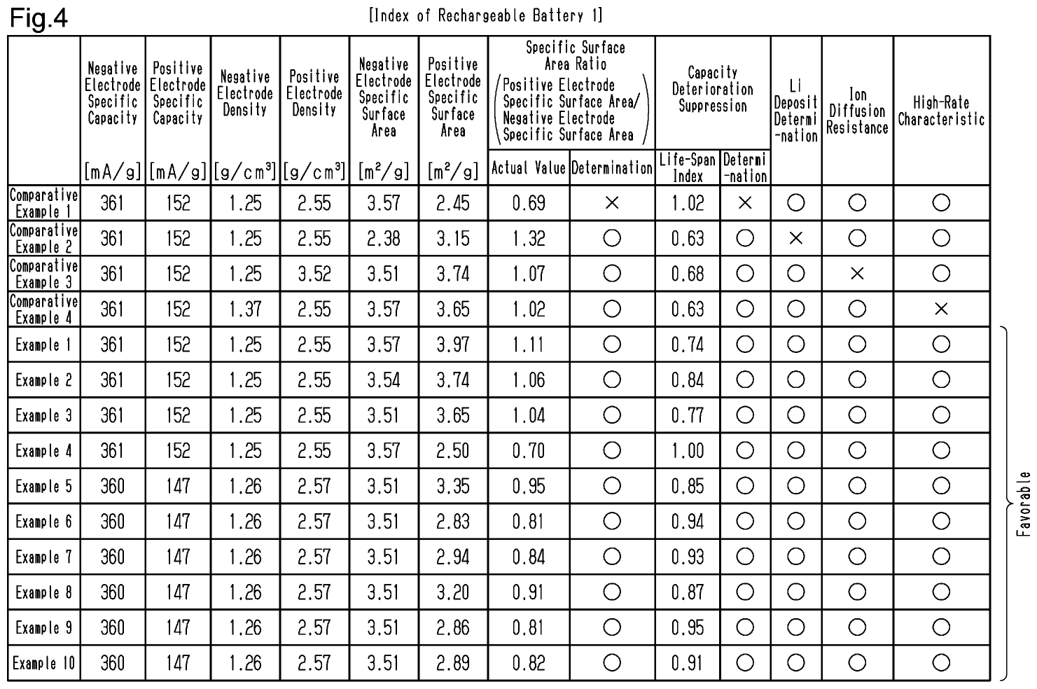

FIG. 4 is a table showing index values in examples and comparative examples of the electrode body 6. The table of FIG. 4 includes, for example, index columns for negative electrode specific capacity (mA/g), positive electrode specific capacity (mA/g), negative electrode density (g/cm³), positive electrode density (g/cm³), negative electrode specific surface area (m²/g), positive electrode specific surface area (m²/g), specific surface area ratio, capacity deterioration suppression, Li deposit determination, ion diffusion resistance, and high-rate characteristic. Ten samples of Examples 1 to 10 were compared with comparison references of Comparative Examples 1 to 4. The meaning of each index is described as below.

Negative electrode specific capacity: capacity of negative electrode plate 12 per gram

Positive electrode specific capacity: capacity of positive electrode plate 13 per gram

Negative electrode density: mass of negative electrode mixture layer 17 per unit volume

Positive electrode density: mass of positive electrode mixture layer 21 per unit volume

Negative electrode specific surface area: specific surface area of negative electrode plate 12

Positive electrode specific surface area: specific surface area of positive electrode plate 13

Specific surface area ratio: value obtained by dividing positive electrode specific surface area by negative electrode specific surface area (positive electrode specific surface area/negative electrode specific surface area)

Capacity deterioration suppression: determination result of whether capacity deterioration suppression of rechargeable battery 1 is favorable

Li deposit determination: determination result of whether Li deposition amount is favorable

Ion diffusion resistance: determination result of whether positive electrode reaction resistance is favorable

High-rate characteristic: determination result of whether lithium concentration variation in negative electrode during rapid charging/discharging is favorable

In the determination of capacity deterioration suppression, the life-span of the rechargeable battery 1 was obtained to calculate a life-span index. Then, the determination was performed on the life-span index. As indicated in Comparative Example 1, an “unfavorable” determination was given for capacity deterioration suppression when the life-span index was greater than 1.01. Accordingly, in the present example, the specific surface area ratio (ratio of specific surface area of positive electrode plate 13 to specific surface area of negative electrode plate 12) was set to 0.7 or greater. A specific surface area is measured by, for example, a gas adsorption measurement method using a Brunauer-Emmett-Teller (BET) equation, that is, a BET method.

The operation of the electrode body 6 (rechargeable battery 1 and method for manufacturing electrode body) of the present embodiment will now be described.

Optimization of Specific Surface Area Ratio

As shown in FIG. 4, the specific surface area ratio was set by adjusting at least one of the positive electrode specific surface area and the negative electrode specific surface area. The positive electrode specific surface area and the negative electrode specific surface area were adjusted by, for example, selecting the type of the positive electrode conductive material or setting a pressing condition in the pressing step. Preferably, the positive electrode conductive material is, for example, a material having a specific surface area in a range of 150 m²/g to 300 m²/g, inclusive, specifically, the above-described carbon nanotubes, carbon nanofibers, or the like.

The pressing condition in the pressing step includes, for example, the pressure, pressing speed, and the like. Specifically, when manufacturing the positive electrode plate 13, a predetermined pressure and a predetermined pressing speed are set in the pressing step so that the positive electrode specific surface area is adjusted to a desired specific surface area. Preferably, the pressure is, for example, in a range of 50 kN to 196 kN, inclusive. Preferably, the pressing speed is, for example, in a range of 6 m/min to 60 m/min, inclusive. The negative electrode specific surface area is adjusted in the same manner as the positive electrode specific surface area.

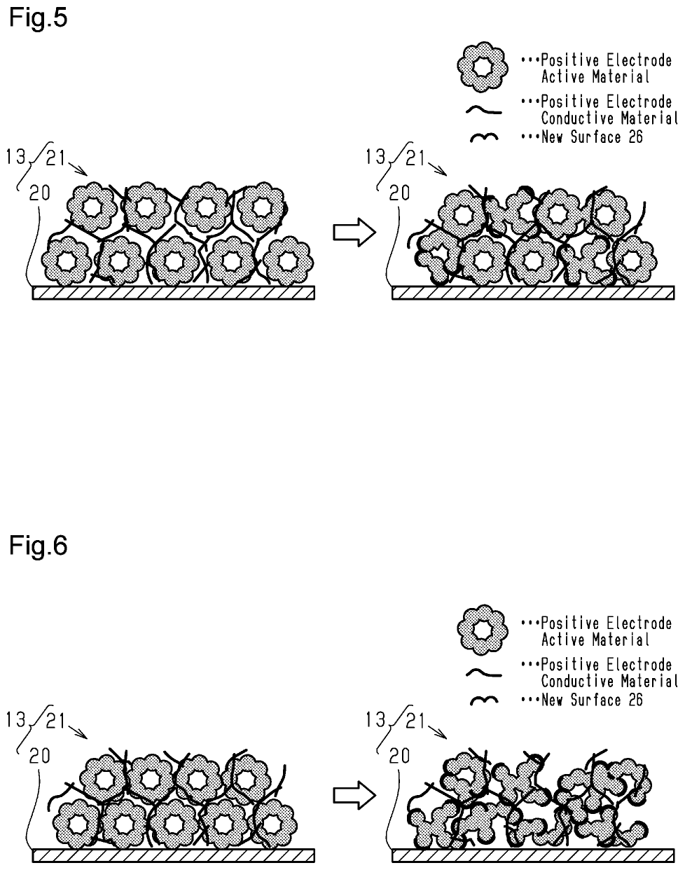

FIGS. 5 and 6 are model diagrams showing the material of the positive electrode plate 13 subsequent to pressing. FIG. 5 is a diagram of a case in which the positive electrode specific surface area is not well-balanced with the negative electrode specific surface area. FIG. 6 is a diagram of a case in which the specific surface area ratio is optimized (more specifically, specific surface area ratio is 0.7 or greater).

When the positive electrode plate 13 is pressed, the pressure cracks the particles of the positive electrode active material so that a new surface 26 of the positive active material is exposed to the outside. For example, the new surface 26 includes a large amount of the active site that chemically reacts with the material of the rechargeable battery 1.

In the activation phase, a side reaction aside from the intended reaction occurs in each of the positive and negative electrodes. The side reaction of the positive electrode includes, for example, formation of a coating on the new surface 26 of the positive electrode active material. The side reaction of the negative electrode includes, for example, formation of a coating, other than the SEI coating, on the negative electrode active material. In addition to those effects described above, the side reaction includes various types such as decomposition of the non-aqueous electrolyte 7.

As shown in FIG. 5, when the positive electrode specific surface area is not well-balanced with the negative electrode specific surface area, the new surface 26 of the positive electrode active material will be limited. It is understood that the amount of cracks is small in the positive electrode active material because the specific surface area ratio is not optimized, that is, the type of the conductive material, the pressing method, and the like are not optimized. Accordingly, in the activation phase, the positive electrode has less side reaction than that of the negative electrode. In other words, the degree of side reaction varies between the positive electrode and the negative electrode.

The negative electrode has a high degree of side reaction in the activation phase so that the capacity greatly changes between before and after the activation phase. Thus, if the positive electrode has a low degree of side reaction and a change in the capacity is small between before and after the activation phase, a difference in the capacity between the positive and negative electrodes increases after the activation phase. Since such a capacity difference affects the capacity of the rechargeable battery 1, the voltage, for example, of the rechargeable battery 1 may quickly reach a lower limit voltage when the rechargeable battery 1 is discharged.

The capacity difference refers to, for example, a difference between a single-electrode capacity of the negative electrode, obtained from the negative electrode specific capacity and the negative electrode active material, and a single-electrode capacity of the positive electrode, obtained from the positive electrode specific capacity and the positive electrode active material. The single-electrode capacity of the negative electrode is, for example, a value obtained by multiplying the negative electrode specific capacity and the amount of the negative electrode active material. The single-electrode capacity of the positive electrode is, for example, a value obtained by multiplying the positive electrode specific capacity and the amount of the positive electrode active material.

As shown in FIG. 6, for example, when the specific surface area ratio is optimized through the setting of the type of the positive electrode conductive material, the pressing condition, and the like, many cracks will form in the positive electrode active material. The increased new surface 26 in the positive electrode active material facilitates the side reaction of the positive electrode during the activation phase. This decreases the difference in the degree of side reaction between the positive and negative electrodes during the activation phase and, in turn, decreases the difference in the single-electrode capacity between the negative and positive electrodes.

As indicated in Comparative Example 1 and Examples 1 to 10 of FIG. 4, when the specific surface area ratio was set to 0.7 or greater and both the positive electrode density and the negative electrode density were low (in present example, positive electrode density of 3.0 g/cm³ or less, negative electrode density of 1.3 g/cm³ or less), a “favorable” determination was given for capacity deterioration suppression. This indicates that the life-span of the rechargeable battery 1 was improved.

Range of Specific Surface Area of Positive and Negative Electrodes

As indicated in Comparative Example 1 of FIG. 4, when the positive electrode specific surface area was too small, capacity deterioration suppression was not “favorable”. As indicated in Example 4, when the positive electrode specific surface area was 2.5 m²/g, capacity deterioration suppression was “favorable”. This indicates that there is a limit to decreasing the positive electrode specific surface area. Taking into consideration the range of the specific surface area ratio, it is preferred that the range of the positive electrode specific surface area be, for example, in a range of 2.5 m²/g to 4.0 m²/g, inclusive.

Since the negative electrode receives ions during charging, the specific surface area of the negative electrode needs to be appropriately large. Also, as indicated in Comparative Example 2, when the negative electrode specific surface area was too small, the Li deposit was not “favorable”. When an “unfavorable” determination is given for Li deposit, the lithium deposit may cause short circuiting, which will not be desirable. Thus, taking into consideration the range of the specific surface area ratio, it is preferred that the range of the negative electrode specific surface area be, for example, in a range of 3.5 m²/g to 4.5 m²/g, inclusive. An upper limit value of the positive electrode specific surface area and the negative electrode specific surface area is, for example, the specific surface area of an electrode (negative electrode plate 12 and positive electrode plate 13) formed when the maximum pressure is applied by a pressing machine.

Ranges of Positive Electrode Density and Negative Electrode Density

As indicated in Comparative Example 3, when the positive electrode density was 3.52, ion diffusion resistance was not “favorable”. When ion diffusion resistance is “unfavorable,” output of the rechargeable battery 1 will decrease. Thus, in the present example, it is preferred that the positive electrode density be less than or equal to 3.0 g/cm³. When the positive electrode density was set low, ion diffusion resistance was “favorable”.

As indicated in Comparative Example 4, when the negative electrode density was 1.37, high-rate characteristic was not “favorable”. When an “unfavorable” determination is given for high-rate characteristic, the negative electrode may cause deterioration of the rechargeable battery 1. Thus, in the present example, it is preferred that the negative electrode density be less than or equal to 1.3 g/cm³. When the negative electrode density was set low, ion diffusion resistance was “favorable”.

Range of Positive-Negative Electrode Capacity Ratio

As described above, the negative electrode receives ions during charging. Thus, it is preferred that the negative electrode be greater in capacity to a certain extent than the positive electrode. Thus, when a value obtained by dividing the single-electrode capacity of the negative electrode by the single-electrode capacity of the positive electrode is referred to as a positive-negative electrode capacity ratio, it is preferred that the positive-negative electrode capacity ratio be, for example, in a range of 1.5 to 2.0, inclusive. In this case, the negative electrode, which receives ions during charging, has a sufficient capacity.

### Advantages of the Embodiment

The electrode body 6 (rechargeable battery 1, electrode body manufacturing method) of the above embodiment has the following advantages.

(1) The electrode body 6 includes a stack of the negative electrode plate 12, the positive electrode plate 13, and the separator 14 in which the separator 14 is arranged between the negative electrode plate 12 and the positive electrode plate 13. The electrode body 6 is configured such that the positive electrode plate 13 has a positive electrode density of 3.0 g/cm³ or less, the negative electrode plate 12 has a negative electrode density of 1.3 g/cm³ or less, and a ratio of a specific surface area of the positive electrode plate 13 to a specific surface area of the negative electrode plate 12 is 0.7 or greater.

With this structure, the specific surface area ratio of the positive and negative electrodes is 0.7 or greater. Thus, the positive electrode plate 13 has a sufficient specific surface area. Accordingly, for example, when preparing the positive electrode mixture layer 21, the new surface 26 formed in the positive electrode active material is increased. This intensifies the degree of side reaction in the positive electrode during the activation phase. Thus, the difference in the degree of side reaction between the positive electrode and the negative electrode will decrease. When the difference in the degree of side reaction decreases between the positive and negative electrodes, the capacity difference between the positive and negative electrodes will be small after the activation phase.

In such an electrode body 6 having low-density electrodes, namely, the positive electrode density of 3.0 g/cm³ or less and the negative electrode density of 1.3 g/cm³ or less, the capacity difference is decreased between the positive and negative electrodes. This improves the life characteristic of the rechargeable battery 1. As a result, the battery performance qualities of the low-density electrodes are enhanced. Further, when the positive and negative electrodes have low densities, the non-aqueous electrolyte 7 permeates the electrode body 6 at a relatively higher rate.

(2) The specific surface area of the positive electrode plate 13 is set to a range of 2.5 m²/g to 4.0 m²/g, inclusive. Further, the specific surface area of the negative electrode plate 12 is set to a range of 3.5 m²/g to 4.5 m²/g, inclusive. With this structure, the positive and negative electrodes have optimized specific surface areas. This further improves the battery characteristics.

(3) The specific surface area has an upper limit value that corresponds to the maximum pressure applied by a pressing machine that presses an electrode plate. This structure sets the specific surface area in a wide range including the maximum pressure applied by the pressing machine.

(4) When the ratio of the single-electrode capacity of the negative electrode, obtained from the specific capacity of the negative electrode plate 12 and the negative electrode active material, to the single-electrode capacity of the positive electrode, obtained from the specific capacity of the positive electrode plate 13 and the positive electrode active material, is referred to as the positive-negative electrode capacity ratio, the positive-negative electrode capacity ratio is in a range of 1.5 to 2.0, inclusive. With this structure, when the rechargeable battery 1 is actuated and ions are sent from one of the positive and negative electrodes and received by the other, the receiving electrode has a sufficient capacity. This further improves the battery performance qualities.

(5) The positive electrode plate 13 includes the positive electrode conductive material that reduces the resistance of the electrode, and the positive electrode conductive material is set to have a specific surface area in a range of 150 m²/g to 300 m²/g, inclusive. With this structure, the specific surface area of the positive electrode conductive material is set such that the particles of the positive electrode active material are readily cracked. For example, if the amount of the positive electrode conductive material is too large, the positive electrode conductive material acts as cushions when preparing the positive electrode mixture layer 21, thereby decreasing cracks in the positive electrode active material. This may result in an insufficient amount of the new surface 26. Thus, the specific surface area of the positive electrode conductive material is optimized accordingly to form a sufficient amount of the new surface 26 in the positive electrode active material.

### Other Embodiments

The present embodiment may be modified as follows. The present embodiment and the following modifications can be combined as long as the combined modifications remain technically consistent with each other.

Preferably, the ratio (specific surface area ratio) of the specific surface area of the positive electrode plate 13 to the specific surface area of the negative electrode plate 12 is greater than or equal to 0.8. This further suppresses capacity deterioration and, in turn, increases the battery life.

The method for adjusting the specific surface area ratio is not limited to selecting the type of the conductive material or the pressing condition. For example, the specific surface area ratio may be adjusted by another method such as selecting the material of the positive electrode or improving a kneading method.

The negative electrode binder may be, for example, styrene-butadiene rubber (SBR), polyvinylidene fluoride (PVDF), polyvinyl alcohol (PVA), or the like.

Both the negative and positive electrodes may use any types of active material, conductive material, solvent, and binder.

The rechargeable battery 1 is not limited to the lithium-ion type and may be of a different type.

The rechargeable battery 1 does not have to have the form of a thin plate and may have, for example, a cylindrical shape.

The rechargeable battery 1 does not have to be mounted on a vehicle and may be used in a marine vessel, an aircraft, or the like. Further, the rechargeable battery 1 may be a stationary battery.

The present disclosure described in accordance with examples is to be considered as illustrative and not restrictive, and the present disclosure is not to be limited to the details given herein, but may be modified within the scope and equivalence of the appended claims.

What is claimed is:

1. An electrode body, comprising:
a stack of a negative electrode plate, a positive electrode plate, and a separator in which the separator is arranged between the negative electrode plate and the positive electrode plate, wherein
the positive electrode plate has a positive electrode density of 3.0 g/cm³ or less,
the negative electrode plate has a negative electrode density of 1.3 g/cm³ or less, and
a ratio of a specific surface area of the positive electrode plate to a specific surface area of the negative electrode plate is 0.7 or greater.

2. The electrode body according to claim 1, wherein:
the specific surface area of the positive electrode plate is set to a range of 2.5 m²/g to 4.0 m²/g, inclusive; and
the specific surface area of the negative electrode plate is set to a range of 3.5 m²/g to 4.5 m²/g, inclusive.

3. The electrode body according to claim 2, wherein the specific surface area has an upper limit value that corresponds to a maximum pressure applied by a pressing machine that presses an electrode plate.

4. The electrode body according to claim 1, wherein when a ratio of a single-electrode capacity of a negative electrode, obtained from a specific capacity of the negative electrode plate and a negative electrode active material, to a single-electrode capacity of a positive electrode, obtained from a specific capacity of the positive electrode plate and a positive electrode active material, is referred to as a positive-negative electrode capacity ratio, the positive-negative electrode capacity ratio is in a range of 1.5 to 2.0, inclusive.

5. The electrode body according to claim 1, wherein
the positive electrode plate includes a positive electrode conductive material that reduces resistance of an electrode, and
the positive electrode conductive material has a specific surface area set in a range of 150 m²/g to 300 m²/g, inclusive.

6. A rechargeable battery, comprising:
an electrode body including a stack of a negative electrode plate, a positive electrode plate, and a separator in which the separator is arranged between the negative electrode plate and the positive electrode plate, wherein
the positive electrode plate has a positive electrode density of 3.0 g/cm³ or less,
the negative electrode plate has a negative electrode density of 1.3 g/cm³ or less, and
a ratio of a specific surface area of the positive electrode plate to a specific surface area of the negative electrode plate is 0.7 or greater.

7. A method for manufacturing an electrode body, the electrode body including a stack of a negative electrode plate, a positive electrode plate, and a separator in which the separator is arranged between the negative electrode plate and the positive electrode plate, the method comprising:
setting a positive electrode density of the positive electrode plate to 3.0 g/cm³ or less;
setting a negative electrode density of the negative electrode plate to 1.3 g/cm³ or less; and
setting a ratio of a specific surface area of the positive electrode plate to a specific surface area of the negative electrode plate to 0.7 or greater.
